(19) United States
(12) Patent Application Publication
(10) Pub. No.: US 2022/0337107 A1
(43) Pub. Date: Oct. 20, 2022

(54) ELECTRIC MOTOR, ROTOR AND METHOD FOR SECURING A MAGNET IN A ROTOR

(71) Applicant: Schaeffler Technologies AG & Co. KG, Herzogenaurach (DE)

(72) Inventors: Alexandre FISCHER, Strasbourg (FR); Thomas FRITZ, Rheinstetten (DE)

(73) Assignee: Schaeffler Technologies AG & Co. KG, Herzogenaurach (DE)

(21) Appl. No.: 17/641,522

(22) PCT Filed: Aug. 25, 2020
(86) PCT No.: PCT/DE2020/100745

§ 371 Date: Mar. 9, 2022

(30) Foreign Application Priority Data
Sep. 10, 2019 (DE) 10 2019 124 185.5

(51) Int. Cl. H02K 1/276; H02K 1/28; H02K 15/03

(52) U.S. Cl. CPC H02K 1/276; H02K 1/28; H02K 15/03; H02K 2213/03

(57) ABSTRACT

A rotor for an electric motor, having a laminated rotor core which is rotatable about a rotation axis and has a plurality of rotor laminations which are arranged axially next to one another, at least one magnet which is held in a magnet cutout in the rotor lamination and has a first side face which extends at least along a first side length and a second side face that is oriented at an angle to the first side face and extends at least along a second side length and which is connected by an adhesive to a boundary face of the magnet cutout. An electric motor having a rotor, and a method for seeming a magnet in a rotor are also provided.

### CROSS-REFERENCE TO RELATED APPLICATIONS

This application is the U.S. National Phase of PCT Appln. No. PCT/DE2020/100745, filed Aug. 25, 2020, which claims priority from German Patent Application No. 10 2019 124 185.5, filed Sep. 10, 2019, the entire disclosures of which are incorporated by reference herein.

### TECHNICAL FIELD

The disclosure relates to a rotor. Furthermore, the invention relates to an electric motor comprising a rotor and to a method for securing a magnet in a rotor.

### BACKGROUND

An electric motor is known, for example, from DE 10 2018 129 877 A1. It describes an electric motor that has a rotor equipped with a plurality of magnets. The magnets are connected to the rotor by an adhesive bond. The magnets are wrapped in adhesive tape and placed in cutouts in the rotor. The adhesive tape is wetted with an adhesive. To insert the magnets in the rotor, the composite is heated, which liquefies the adhesive and causes the adhesive bond with the rotor.

It is also known, to insert the magnets in the rotor, by applying adhesive to the magnets, which is then distributed between the magnets and the rotor. The subsequent application of heat causes the adhesive to cure, resulting in an adhesive bond between the magnets and the rotor. A large amount of adhesive should result in sufficient wetting of the joining surfaces between the magnets and the rotor. Nevertheless, incomplete or uneven wetting of the joining surfaces can occur.

If the rotor is constructed from a laminated rotor core as the basic rotor body, the magnets inserted in the laminated rotor core are bonded by a viscous adhesive, as is known. The increased viscosity of the adhesive prevents any unwanted wetting of surfaces other than the intended joining surfaces. However, in order to achieve sufficient wetting of the joining surfaces with the viscous adhesive, a large amount of adhesive is used. In addition, the magnet cutout provided in the laminated rotor core and accommodating the magnets is enlarged so that the viscous adhesive can also reach joining surfaces remote from the introduction point.

### SUMMARY

The object of the present disclosure is to improve the securing of the magnets in the rotor. The magnets should be more reliable, easier, cheaper and faster to secure in the rotor. The rotor should be simpler, cheaper and more efficient. The securing method should be implemented in a faster, easier and cheaper manner.

At least one of these objects is achieved by a rotor having one or more of the features disclosed herein. As a result, the amount of adhesive to be applied can be reduced. The rotor can be built more cost-effectively and efficiently.

The magnet cutout can be punched out of the rotor lamination. The magnet cutout can be axially continuous through the rotor lamination.

The first side length can be a magnet width, preferably perpendicular to an axial direction parallel to the rotation axis. The second side length can be a magnet height, preferably perpendicular to the axial direction and to the magnet width. The first side face can be spanned by a magnet length, preferably parallel to the axial direction, and the first side length. The second side face can be spanned by a magnet length, preferably parallel to the axial direction, and the second side length.

The adhesive can be introduced via the distribution opening into the magnet cutout when magnets are inserted and distributed in the distribution opening and from there between the boundary face and the magnet. The distribution opening allows the adhesive to be distributed in the laminated rotor core from one rotor lamination to the axially adjacent rotor lamination.

In a preferred embodiment, the first and/or second side face is spaced apart from the boundary face by boundary means projecting from the rotor lamination in the direction towards the magnet, forming a gap. The boundary means can be provided integrally with the rotor lamination.

In a particular embodiment, a maximum gap distance of the gap between the boundary face and the magnet is in a range from 0.01 to 0.2 times the first or second side length. With this, the amount of adhesive filling the gap can be reduced.

In a particularly preferred embodiment of the invention, a maximum gap length of the gap perpendicular to the gap length and parallel to the first or second side length is in a range from 0.2 to 1.0 times the first or second side length. This allows a stable bond to be achieved between the rotor lamination and the magnet.

In a particular embodiment, the boundary means comprise a first boundary means and, spaced apart from this, a second boundary means, each for abutting the first or second side face. The magnet, with its first or second side face, can abut the boundary face solely via the first and second boundary means. This allows for a predetermined alignment of the magnet within the magnet cutout.

In another particular embodiment, the gap extends between the first and second boundary means. This allows the gap in the rotor lamination to be easily executed.

In a preferred embodiment, the magnet has a rectangular cross-section and the first side face is perpendicular to the second side face. This allows the magnet to be easily and cost-effectively executed.

Furthermore, an electric motor for a drive train of a vehicle is proposed for achieving at least one of the aforementioned objects, comprising a stator and a rotor rotatable relative to the stator and having at least one of the aforementioned features.

The electric motor can be a permanently excited synchronous motor. The drive train can be a hybrid drive train. The vehicle can be an electric vehicle. The electric motor can provide drive torque to move the vehicle.

Furthermore, for achieving at least one of the previously stated objects, a method for securing a magnet in a rotor having at least one of the previously stated features is proposed, wherein the magnet is secured in the rotor lamination by heating the laminated rotor core, subsequently inserting the magnet into the magnet cutout and aligning the magnet via the fastening means in the magnet cutout, then introducing adhesive into the gap, and subsequently curing the adhesive by means of UV irradiation.

This allows for a cost-effective and quick securing between magnet and rotor lamination to be implemented. A heat treatment for curing can be omitted. The heating can be done at a temperature between 30° C. and 50° C. This allows the viscosity of the adhesive to be reduced and reliable wetting of the joining surfaces to be achieved.

In a particular embodiment, the adhesive is a low viscosity adhesive having a viscosity between 0.05 and 1.2 mPa·s when introduced. This allows for a more cost-effective securing between the magnet and the rotor lamination. The amount of adhesive required is reduced. Also, a faster feed of the adhesive into the gap can be achieved.

The adhesive can be an anaerobic curing adhesive. The stated viscosity can be at room temperature. The stated viscosity can be at a temperature between 30° C. and 50° C.

### BRIEF DESCRIPTION OF THE DRAWINGS

Further advantages and advantageous embodiments according to the disclosure result from the description of the figures and the drawings.

The invention is described in detail below with reference to the drawings. Specifically:

FIG. 1: shows a three-dimensional view of an electric motor in a specific embodiment.

FIG. 2: shows a three-dimensional view of an electric motor in a specific embodiment.

FIG. 3: shows a side view of a rotor lamination of a rotor in a specific embodiment.

FIG. 4: shows the section A of FIG. 3 in a magnified view.

FIG. 5: shows a flowchart of a method in a specific.

### DETAILED DESCRIPTION

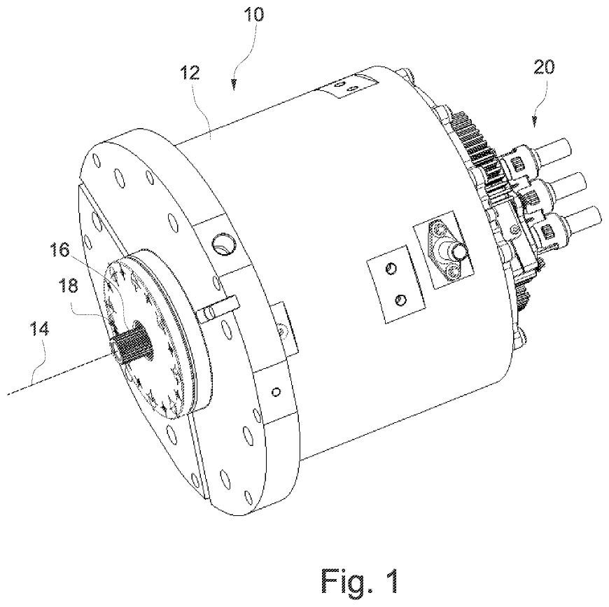

FIG. 1 shows a three-dimensional view of an electric motor 10 in a specific embodiment according to the disclosure. The electric motor 10 is designed as a permanently excited synchronous motor and has a stator 12 and a rotor arranged radially inside the stator 12 so as to be rotatable about a rotation axis 14. The rotor is connected to a motor shaft 16 in a non-rotatable manner. The motor shaft 16 comprises a toothing 18 for connection to a connecting component for transmitting drive torque caused by the rotor.

The stator 12 is supplied with electrical energy via three motor phase leads 20. Several coils built up by wire winding are arranged in the stator 12, via which the electrical energy is converted into a rotating electromagnetic field acting on the rotor. The heat energy thus generated during operation of the electric motor 10 is dissipated via a motor cooling means.

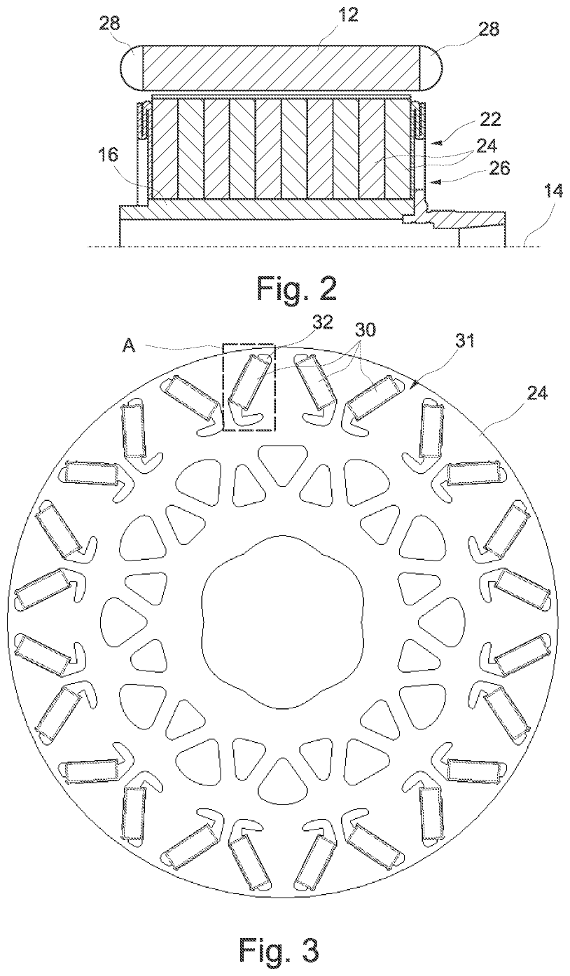

FIG. 2 shows a half section of an electric motor 10 in another specific embodiment. The rotor 22 has a plurality of rotor laminations 24 arranged axially adjacent to one another and rotatable as a whole about the rotation axis 14, which are connected in a non-rotatable manner to the motor shaft 14 and form a laminated rotor core 26. The individual rotor laminations 24 can be stamped from sheet metal.

The stator 12 has a plurality of circumferentially distributed wire-wound coils 28 which can be supplied with electrical energy and, depending thereon, cause a rotational magnetic field acting on the laminated rotor core 26. Magnets, which are configured as permanent magnets, are received in the laminated rotor core 26. The magnets convert the rotational magnetic field into a torque that is transmitted to the motor shaft 16.

FIG. 3 shows a top view of a rotor lamination 24 of a rotor 22 in a specific embodiment according to the disclosure. The rotor lamination 24 has a plurality of magnets 30 distributed circumferentially and received in a respective magnet cutout 32 in the rotor lamination 24, preferably stamped from the rotor lamination 24. The magnets 30 are arranged in a position predetermined by a magnet arrangement 31 and distributed circumferentially in such a way as to minimize imbalance of the rotor lamination 24 and to provide a required number of poles in the rotor lamination 24. The magnets 30 are glued into the respective magnet cutout 32 with an adhesive. In particular, the magnet cutout 32 extends axially through the rotor lamination 24 and the magnet 30 is arranged to be axially continuous in the magnet cutout 32.

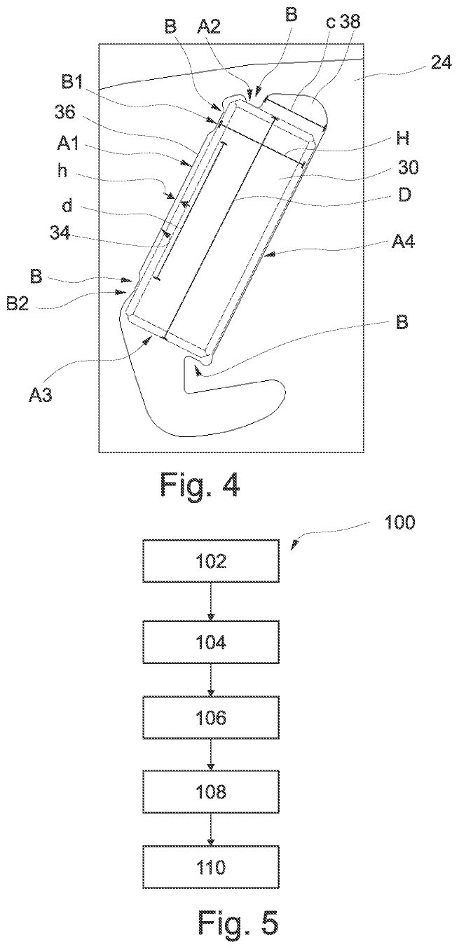

FIG. 4 shows a magnified view of section A of FIG. 3. The single magnet 30 has a first side face A1 spanned by a magnet length extending perpendicular to the sheet plane and a first side length, here a magnet width D, and a second side face A2 oriented at an angle to the first side face A1 and spanned by the magnet length and a second side length, here a magnet height H. The first and second side faces A1, A2 are oriented perpendicular to one another. The magnet 30 has a rectangular cross-section and the magnet width D is greater than the magnet height H. The first side face A1 faces a corresponding side face A3 in the direction of the magnet height H. The second side face A2 faces a corresponding side face A4 in the direction of the magnet width D.

The magnet 30 is bonded to a boundary face 34 of the magnet cutout 32 by an adhesive. The magnet cutout 32 comprises boundary means B projecting from the rotor lamination 24 in the direction towards the magnet 30 for abutting the magnet 30. The boundary means B allow the magnet 30 to be aligned and fixed in the magnet cutout 32. The boundary means B have a first boundary means B1 and a second boundary means B2 spaced apart from it in the direction of the magnet width D, each for abutting the first side face A1.

The first side face A1 is spaced apart from the boundary face 34 by the first and second boundary means B1, B2, forming a gap 36. The adhesive for the adhesive connection between the magnet 30 and the boundary face 34 is preferably a low viscosity adhesive with a viscosity between 0.05 and 1.2 mPa·s and can thus be distributed evenly and completely in the gap 36 and thus connect the joining surfaces of the boundary face 34 and the magnet 30 with a material bond.

The gap 36 extends parallel to the magnet width D between the first and second boundary means B1, B2. The magnet 30 abuts the boundary face 36 with the first side face A1 solely via the first and second boundary means B1, B2. A maximum gap distance h of the gap 36 between the boundary face 34 and the magnet 30 is in a range from 0.01 to 0.2 times the magnetic height H, and a maximum gap length d of the gap 36 perpendicular to the gap distance h and parallel to the magnet width D is in a range from 0.2 to 1.0 times the magnet width D.

If the adhesive cannot be designed to be of a low viscosity as previously indicated, but is of a higher viscosity, then in addition or as an alternative to the design of the joining surfaces within the gap 36, a distribution opening 38 is made in the magnet cutout 32 extending between the second side face A2 and the boundary face 34. The lower or higher viscosity adhesive can be introduced into the magnet cutout 32 via the distribution opening 38 when the magnets 30 are inserted, and can be distributed into the distribution opening 38 and outward from it between the boundary face 34 and the magnet 30. The distribution opening 38 allows the adhesive to be distributed evenly in the laminated rotor core from one rotor lamination 24 to the axially adjacent rotor lamination. The distribution opening 38 has a maximum extension c with respect to the magnet height H, which is smaller than the magnet height H. As a result, the amount of adhesive to be applied can be reduced. The rotor can be built more cost-effectively and efficiently.

FIG. 5 shows a flowchart of a method 100 in a specific embodiment according to the disclosure. Using the method 100 for securing a magnet in a rotor, the magnet is secured in the rotor lamination by first performing a heating 102 of the laminated rotor core, preferably with a temperature between 30° C. and 50° C., followed by an insertion 104 of the magnet into the magnet cutout of the rotor lamination. In doing so, an alignment 106 of the magnet is performed via the fastening means in the magnet cutout. Subsequently, an introduction 108 of adhesive into the gap is performed and finally the curing 110 of the adhesive takes place by means of UV irradiation. This allows for a cost-effective and quick securing between magnet and rotor lamination to be implemented. A heat treatment for curing the adhesive can be omitted.

### LIST OF REFERENCE NUMERALS

10 Electric motor
12 Stator
14 Rotation axis
16 Motor shaft
18 Toothing
20 Motor phase lead
22 Rotor
24 Rotor lamination
26 Laminated rotor core
28 Coil
30 Magnet
31 Magnet arrangement
32 Magnet cutout
34 Boundary face
36 Gap
38 Distribution opening
100 Method
102 Heating
104 Insertion
106 Alignment
108 Introduction
110 Curing
A1 First side face
A2 Second side face
B Boundary means
B1 First boundary means
B2 Second boundary means
c Maximum extension
d Gap length
D Magnet width
h Gap distance
H Magnet height

1. A rotor for an electric motor, the rotor comprising:
a laminated rotor core which is rotatable about a rotation axis and has a plurality of rotor laminations which are arranged axially next to one another;
at least one magnet which is held in a magnet cutout in the rotor lamination and has a first side face which extends at least along a first side length and a second side face that is oriented at an angle to the first side face and extends at least along a second side length and which is connected by an adhesive to a boundary face of the magnet cutout;
wherein the magnet cutout has a distribution opening extending between the second side face and the boundary face for receiving and passing the adhesive between the rotor laminations, which has a maximum extension relative to the second side length which is smaller than the second side length.

2. The rotor according to claim 1, wherein at least one of the first or the second side face is spaced apart from the boundary face via boundary elements projecting from the rotor lamination in a direction towards the magnet, forming a gap.

3. The rotor according to claim 2, wherein a maximum gap distance of the gap between the boundary face and the magnet is in a range from 0.01 to 0.2 times the first or second side length.

4. The rotor according to claim 3, wherein a maximum gap length of the gap perpendicular to the gap distance and parallel to the first or second side length is in a range from 0.2 to 1.0 times the first or second side length.

5. The rotor according to claim 2, wherein the boundary elements comprise a first boundary protrusion and, spaced apart from this, a second boundary protrusion, each for abutting the first or second side face.

6. The rotor according to claim 5, wherein the gap runs between the first and second boundary protrusions.

7. The rotor according to claim 1, wherein the magnet has a rectangular cross-section and the first side face is perpendicular to the second side face.

8. An electric motor for a drive train of a vehicle, the electric motor comprising a stator and the rotor according to claim 1, the rotor being rotatable relative to the stator.

9. A method for securing a magnet in the rotor according to claim 2, the method comprising:
securing the magnet in the rotor lamination by heating of the laminated rotor core;
then, inserting the magnet into the magnet cutout and aligning the magnet via the boundary elements in the magnet cutout;
then introducing adhesive into the gap; and finally, curing the adhesive by UV irradiation.

10. The method according to claim 9, wherein the adhesive is a low viscosity adhesive having a viscosity between 0.05 and 1.2 mPa·s when introduced.

11. A rotor for an electric motor, the rotor comprising:
a laminated rotor core which is rotatable about a rotation axis and has a plurality of rotor laminations which are arranged axially next to one another;
a plurality of magnets held in magnet cutouts in the rotor laminations, the magnets each having a first side face which extends at least along a first side length and a second side face that is oriented at an angle to the first side face and extends at least along a second side length and which is connected by an adhesive to a boundary face of a respective one of the magnet cutouts;
wherein at least some of the magnet cutouts have a distribution opening extending between the second side face and the boundary face for receiving and passing the adhesive between the rotor laminations, which has a maximum extension relative to the second side length which is smaller than the second side length.

12. The rotor 1 according to claim 11, wherein for each of the magnets, at least one of the first or the second side face is spaced apart from the boundary face via boundary elements projecting from the rotor laminations in a direction towards each said magnet, forming a gap.

13. The rotor according to claim 12, wherein a maximum gap distance of the gap between the respective boundary face and each said magnet is in a range from 0.01 to 0.2 times the first or second side length.

14. The rotor according to claim 13, wherein a maximum gap length of each said gap perpendicular to the gap distance and parallel to the first or second side length is in a range from 0.2 to 1.0 times the first or second side length.

15. The rotor according to claim 12, wherein the boundary elements of each said magnet cutout comprise a first boundary protrusion and, spaced apart therefrom, a second boundary protrusion, each for abutting the first or second side face.

16. The rotor according to claim 15, wherein the gap runs between the first and second boundary protrusions.

17. The rotor according to claim 11, wherein each said magnet has a rectangular cross-section and the first side face is perpendicular to the second side face.

18. An electric motor for a drive train of a vehicle, the electric motor comprising a stator and the rotor according to claim 11, the rotor being rotatable relative to the stator.
